(19) United States
(12) Patent Application Publication
(10) Pub. No.: US 2018/0116232 A1
(43) Pub. Date: May 3, 2018

(54) CRISP AND CHEWY TEXTURE COOKIE

(71) Applicant: CHERYL PARHAM, LEWISTON, ID (US)

(72) Inventor: CHERYL PARHAM, LEWISTON, ID (US)

(21) Appl. No.: 15/339,362

(22) Filed: Oct. 31, 2016

(51) Int. Cl. A21D 13/08

(52) U.S. Cl. CPC A21D 13/08

(57) ABSTRACT

The invention relates to oatmeal cookie with their composition which mainly includes sugar (brown, golden), butter or margarine, eggs, salt, vanilla extract, baking soda, baking soda, gold medal flour, Quaker oats (uncooked), coconut and cinnamon. The product, when baked, provides a storage-stability, plurality of textures, a crisp texture, and chewy texture. This invention also provided a method for preparation of an oatmeal cookie comprising the steps of: (i) mixing of the dry ingredients and the eggs together in butter or margarine with the help of hands; (ii). Adding all remaining ingredients and roll into balls and flatten with fork in both directions; (iii) Filling the obtained product into a container.

### FIELD OF THE INVENTION

The present invention relates to baked food products, in particular, cookies. Moreover, the invention relates to a process for preparing such an oatmeal cookie in composition with cinnamon and coconut, where there is an outer layer of crispiness and an inner layer of chewiness.

### BACKGROUND OF THE PREFERRED DISCLOSURE

Oatmeal has for many years been a staple of the human diet due to its health benefits. For example, numerous studies have shown that eating oatmeal on a daily basis can help lower blood cholesterol, reduce risk of heart disease, promote healthy blood flow as well as maintain healthy blood pressure levels. Additionally, oatmeal has a high content of complex carbohydrates and fibers, which facilitates slow digestion and stable blood-glucose levels.

Fresh, home-baked cookies are the standard of excellence in the cookie world. The dominant characteristic of most fresh, home-baked cookies is their texture, specifically a crisp, friable outside surface and a ductile interior. The inside contains pockets of super-saturated sugar solution (syrup) that are ductile and are sometimes visible as strands when the cookie is pulled apart. Unfortunately, within a few weeks, or less, such cookies, undergo a spontaneous and irreversible process of degradation, becoming hard and crumbly throughout. The following disclosed preferred embodiments of the invention describes the Physio-chemical processes that have now been discovered to occur during cookie baking and subsequent storage.

Prior backed cookie texture can be quantified, in terms of stiffness, a measure of stress verses deformation, and plasticity, a measure of the tendency of the cookie crumb to plastic flow. The typical freshly baked homemade cookie has regions of high stiffness/low plasticity (crisp) and regions of low stiffness/high plasticity (chewy). The differences between these regions degrade with time, so that the cookies acquire a uniform texture perceived by consumers as uninteresting and somewhat undesirable.

Prior art cooking patents are legion, wherein the following list of patents are herein incorporated by reference for their supportive teachings, wherein:

U.S. Pat. No. 4,873,093, issued Oct. 10, 1989, by Fazzolare et al., teaches of a starch snack foods and process.

U.S. Pat. No. 5,188,859, issued Feb. 23, 1993, by Lodge et al., teaches of a low fat snack.

US Patent Pub. 2008/0138480, pub. Jun. 12, 2008, by Bows et al., teaches of a process for making a healthy snack food.

U.S. Pat. No. 5,073,387, by Whistler, issued Dec. 17, 1991, teaches of a method for preparing reduced calorie foods.

It would be of value, therefore, to provide cookies, which, having reached substantial textural equilibrium, would still demonstrate strong differences between regions having the maximum stiffness: plasticity ratios (crisp) and those regions having the minimum stiffness: plasticity ratios (chewy).

Thus, what is needed is a food product that has improved nutritional and organoleptic characteristics, yet maintains an appealing appearance, excellent flavor, a long shelf life, and having the maximum stiffness.

### SUMMARY OF THE ILLUSTRATED EMBODIMENTS

In spite of the compositions available priory, there is a need for compositions containing oatmeal, cinnamon and coconut that have excellent flavor, a long shelf life, and having the maximum stiffness.

As such, the general purpose of the present invention, which will be described subsequently in greater detail, is to provide a new and improved recipe of cookie composition containing oatmeal, cinnamon and coconut which have excellent flavor.

According to one aspect of the invention the oatmeal cookie includes the composition of various ingredients such as, sugar (golden brown), butter or margarine, eggs, salt, vanilla extract, baking soda, baking powder, gold medal flour, Quaker Oats® (uncooked), coconut and cinnamon.

It is an object of this invention to provide baked oatmeal cookie product comprises a composition of cinnamon and coconut made from typical cookie ingredients, and is characterized in having distributed therein discrete regions provide a crisp, crunchy texture, and the regions with a low stiffness.

It is an object of the present invention to provide baked oatmeal cookie product that can be packaged and stored, preferably under refrigeration, for baking by the consumer. Such dough products, when baked, produces cookies, which after passage of time retain a crisp/chewy texture profile over long periods of time, when stored in sealed containers.

According to one another aspect of the invention, there is provided a method for preparation of a composition according to any one of the preceding claims, comprising the steps of:

(i) Mixing of the dry ingredients and the eggs together in butter or margarine by hands of a user;

(ii) Adding all remaining ingredients and roll into balls and flatten with fork in both and x and y direction; and

(iii) Placing the obtained product into a container.

In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty that characterize the invention, are pointed out with particularity in the disclosure. For a better understanding of the invention, and its operating advantages and the specific objects attained by its uses.

### DETAILED DESCRIPTION OF THE DISCLOSURE

In the following detailed description provides specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention provides food product in the form of a cookie, or the like, which, when baked, provides a storage-stable plurality of textures, and the cookies made therefrom.

The “cookies” of this invention are of the “crumb-continuous” type, which typically have a predominantly uniform distribution of the ingredients throughout the cookie, e.g. oatmeal cookies, chocolate chip or Toll House™ cookies, peanut butter cookies, sugar cookies, and other drop-type cookies. This is in distinction to the filled, coated, and sandwich-type cookies known in the art.

By “cookie ingredients” is meant those ingredients common to virtually all cookies, namely, sugar, flour, water, and shortening, as well as those additional flavoring and texture ingredients desired in the particular system being formulated. The latter ingredient would include butter or margarine, eggs, salt, vanilla extract, baking soda, gold medal flour, Quaker oats® (uncooked), coconut and cinnamon.

By “Cinnamon” it is considered to be a spice. Herein it is a spice obtained from the inner bark of several trees from the genus Cinnamon is used in both sweet and savory foods.

By “baking” herein is meant radiant, conductive, or convective exposure to the energy of a type that imparts thermal energy to the product that is baked. It thus includes conventional, convection and microwave oven baking.

In a first aspect the invention, there is provided an oatmeal cookie with their composition which mainly includes sugar (brown, golden), butter or margarine, eggs, salt, vanilla extract, baking soda, baking soda, gold medal flour, Quaker oats (uncooked), coconut and cinnamon. The product, when baked, provides a storage-stability, plurality of textures, a crisp texture, and chewy texture.

Preferably the composition of this invention comprises 2 cups of brown sugar, 1 cup butter or margarine, 2 beaten eggs, 1 teaspoon baking powder, ½ teaspoon salt, 1 teaspoon vanilla extract, ½ teaspoon baking soda, 2 cups gold medal® flour, 2 cups Quaker oats® (uncooked-not instant), ½ cup or more of fine shredded coconut (sweetened), and 1 teaspoon of cinnamon.

In another aspect, the invention provides a method for preparation of a composition according to any one of the preceding claims, comprising the steps of:
(i) mixing of the dry ingredients and the eggs together in butter or margarine with the help of hands;
(ii) adding all remaining ingredients and roll into balls and flatten with fork in both an x and y direction;
(iii) placing the obtained product into a container.

In step (1) eggs, preferably holds the ingredients. In step (2) dip the fork in cold water if composition sticks to the fork. In step (3) before filling, grease the aluminum cookie sheet only for 1^{st} batch. Finally, cook the whole composition at 350° C. for 13-15 minutes until the shine looks of the cookies disappears on the surface thereof and immediately remove the aluminum cookie sheet. Thus, creating a crunchy outer layer and a soft inner layer of the cookies.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A method of making an oatmeal cookie which is capable of providing crumb continuous cookie having storage stable, crisp and chewy textures, wherein said composition comprises:
sugar, butter or margarine, eggs, salt, vanilla extract, baking soda, baking powder, gold medal® flour, Quaker oats® (uncooked), coconut and cinnamon.

2. The method of making an oatmeal cookie preform according to claim 1, wherein the sugar is golden brown sugar.

3. The method of making an oatmeal cookie of claim 2, comprising: sugar, butter or margarine, eggs, salt, vanilla extract, baking soda, baking powder, gold medal® flour, Quaker oats® (uncooked), coconut and cinnamon, and uncooked oatmeal.

4. The method of making an oatmeal cookie of claim 3, comprising: cooking the whole composition at 350° C. for 13-15 minutes on an aluminum cookie sheet until the shine looks of the cookies disappears on the surface thereof and immediately remove the aluminum cookie sheet, thereby creating a crunchy outer layer and a soft inner layer of the cookies.

5. The method of making an oatmeal cookie of claim 4, wherein the composition comprises 2 cups of said sugar

6. The method of making an oatmeal cookie of claim 5, wherein the composition comprises 1 cup of said butter or margarine.

7. The method of making an oatmeal cookie of claim 6, wherein the composition comprises 2 beaten eggs.

8. The method of making an oatmeal cookie of claim 7, wherein the composition comprises 1 teaspoon of said baking powder.

9. The method of making an oatmeal cookie of claim 8, wherein the composition comprises ½ teaspoon of said salt.

10. The method of making an oatmeal cookie of claim 9, wherein the composition comprises 1 teaspoon of said vanilla extract.

11. The method of making an oatmeal cookie of claim 10, wherein the composition comprises ½ teaspoon of said baking soda.

12. The method of making an oatmeal cookie of claim 11, wherein the composition comprises 2 cups of said gold medal® floor.

13. The method of making an oatmeal cookie of claim 12, wherein the composition comprises 2 cups of said Quaker oats®.

14. The method of making an oatmeal cookie of claim 13, wherein the Quaker oats® are uncooked.

15. The method of making an oatmeal cookie of claim 14, wherein the composition comprises 1½ or more teaspoon of finely shredded coconuts.

16. The method of making an oatmeal cookie of claim 15, wherein the composition comprises 1 teaspoon of cinnamon.

17. The method of making an oatmeal cookie of claim 15, wherein the composition comprises: cooking the whole composition at 350° C. for 13-15 minutes on an aluminum cookie sheet until the shine looks of the cookies disappears on the surface thereof and immediately remove the aluminum cookie sheet, thereby creating a crunchy outer layer and a soft inner layer of the cookies.
